(19) United States
(12) Patent Application Publication
(10) Pub. No.: US 2025/0042057 A1
(43) Pub. Date: Feb. 6, 2025

(54) Method and device for the mechanical compaction of clayey earth material

(71) Applicant: rematter AG, Zug (CH)

(72) Inventor: Tobias BONWETSCH, Zürich (CH)

(73) Assignee: rematter AG, Zug (CH)

(21) Appl. No.: 18/790,037

(22) Filed: Jul. 31, 2024

(30) Foreign Application Priority Data
Aug. 1, 2023 (EP) 23020360.6

(51) Int. Cl. B28B 1/093; B28B 17/00; E04B 2/84

(52) U.S. Cl. CPC B28B 1/093; B28B 17/0081; E04B 2/84

(57) ABSTRACT

In a method for the mechanical compaction of clayey earth material by means of a vibration plate, in which the vibration plate is guided as an end effector on a triaxial positioning system over the earth material to be compacted and the compressive force applied to the earth material is increased by controlling the positioning system for displacement perpendicular to the plate plane of the vibration plate, the degree of compaction of the earth material during compaction is measured and the compressive force, the duration of the stay of the vibration plate at the same place, the frequency of the vibration movement and/or the amplitude of the vibration movement is controlled as a function of the measured degree of compaction.

### CROSS-REFERENCE TO RELATED APPLICATIONS

The present application claims priority to European Patent Application No. 23020360.6, filed Aug. 1, 2023, entitled “METHOD AND DEVICE FOR THE MECHANICAL COMPACTION OF CLAYEY EARTH MATERIAL”, which is incorporated by reference in its entirety.

### BACKGROUND OF THE INVENTION

### 1. Field of the Invention

The invention relates to a method and a device for the mechanical compaction of clayey earth material by means of a vibration plate, in particular for the production of rammed earth.

### 2. Description of the Related Art

The compaction of rammed earth is typically carried out manually using hand-held pneumatic rammers or motor-driven construction machines such as vibration plates, which are also referred to as plate vibrators or surface vibrators.

Rammed earth is a building material with a centuries-old tradition and has experienced a renaissance in recent decades due to its sustainability and durability. Rammed earth is used in a variety of building applications, especially in house construction. Its natural thermal properties can be harnessed for the construction of walls and floors in buildings, as it helps to regulate temperature and thus both improve comfort and reduce energy consumption. In particular, it has already been proposed to use rammed earth in the production of prefabricated ceiling elements. A corresponding clay-wood composite element is described, for example, in EP 4015730 A1.

Although conventional vibration plates are suitable for the production of rammed earth, they are designed more for soil compaction. Such vibration plates function via at least one shaft equipped with an imbalance, which is driven by a motor. The vibration transmitted to a base plate generates centrifugal forces, which cause the compaction effect and often the forward movement of the vibratory plate.

The soil particles are set in motion by the vibration and at the same time compressed more firmly by pressure. The maximum achievable compaction pressure and the compaction depth depend to a large extent on the weight of the vibration plate, i.e. the weight of the base plate plus the weight of the top mass. High compaction performance can therefore only be achieved with very heavy machines, which are correspondingly difficult to handle.

The degree of compaction achieved is based on the operator's experience and cannot be determined directly. Some newer machines are equipped with vibration sensors on the base plate, which use frequency band analysis to establish a reference to the soil stiffness and can indicate differences in the degree of compaction to the operator via visual signals.

Light-weight vibration plates generate a centrifugal force of 10 kN with a weight of 40 kg. Heavy machines achieve up to 130 kN with a weight of 1,200 kg.

For the production of rammed earth, in which relatively small areas are processed compared to soil compaction, e.g. in an area limited by a formwork or mold, pneumatic rammers or light vibration plates are primarily used due to their accessibility. As a result, a compaction depth of only approximately 8 cm can be achieved. Higher structures must therefore be built up in several individually compacted layers.

Whether sufficient compressive strength of the rammed earth has been achieved can only be determined indirectly and not on the actual component. For this purpose, test cubes with an edge length of 20 cm are produced and tested. The production of the test cubes is rarely identical to the production process of the actual rammed earth component and is therefore only of limited significance. The reason for this is that the degree of compaction depends very much on the nature of the material mixture used in each case, so that the material mixture rather than the compaction process can be tested with such a test cube.

### SUMMARY OF THE INVENTION

The present invention therefore aims to provide a method and a device for the automated compaction of rammed earth, with which a very high compaction pressure (>30 kN) can be achieved and the achievement of a predetermined compaction pressure can be indicated. At the same time, it should also be possible to efficiently compact rammed earth components with a high layer depth. In addition, a controlled, measurable and repeatable compaction performance should be ensured across different material compositions.

To solve this task, the invention provides, according to a first aspect, a method for the mechanical compaction of clayey earth material by means of a vibration plate, in which the vibration plate is guided as an end effector on a triaxial positioning system over the earth material to be compacted and the compressive force applied to the earth material is adjusted by actuating the positioning system perpendicular to the plate plane of the vibration plate, wherein the degree of compaction of the earth material is measured during compaction and the compressive force, the duration of maintaining the vibration plate at the same place, the frequency of the vibration movement and/or the amplitude of the vibration movement are controlled as a function of the measured degree of compaction.

By combining the vibration plate and the triaxial positioning system, the invention enables precise control of the compressive force exerted on the earth material. This allows the degree of compaction to be set and adjusted independently of the weight of the vibration plate. With conventional methods, the degree of compaction was often determined or limited by the weight of the vibration plate or pneumatic rammer, which allowed less precise control over the compaction process.

On the one hand, the triaxial positioning system serves to guide the attached vibration plate in two spatial dimensions over the material to be compacted. On the other hand, by controlling the actuation in the third spatial dimension, it is possible to adjust the compressive force exerted by the vibration plate on the material. Suitable positioning systems can be combined with sensors and control systems to control the position and movement of the vibration plate with high precision.

Any device with which the vibration plate can be displaced as an end effector in three spatial directions and with which pressure can be applied transversely to the material surface via the vibration plate is suitable as a positioning system. For example, the positioning system comprises a robot arm that can move the vibration plate in a triaxial manner with high precision and control. Alternatively, linear guidance systems, such as linear robots or gantry robots, with triaxial adjustment capability can be used.

By measuring the degree of compaction of the earth material according to the invention during compaction, the system can provide feedback that can be used to immediately adjust parameters such as compressive force, dwell time, frequency and/or amplitude of the vibration movement. The degree of compaction can be measured continuously or at specific time intervals. In the case of continuous measurement, real-time monitoring and corresponding real-time adjustment of the compaction parameters can be achieved.

Depending on the measured values of the degree of compaction measurement, one or more of the following compaction parameters can be set. The compressive force exerted by the vibration plate on the earth material is one of the main factors influencing the degree of compaction. A higher pressure generally leads to a higher degree of compaction, as the earth material is compressed more. By using the triaxial positioning system in the present invention, the compressive force can be precisely controlled independently of the weight of the vibration plate, allowing for more precise control of the degree of compaction.

The length of time the vibration plate remains in a given position also affects the degree of compaction. A longer dwell time generally leads to a higher degree of compaction, as the earth material is compressed for longer. The lower the forward movement rate of the vibration plate at an identical amplitude, the greater the amount of energy introduced into the compaction process.

The frequency at which the vibration plate vibrates is another factor in the degree of compaction. A lower frequency can result in the earth material being compacted with a greater depth effect. A high frequency (e.g. over 50 Hz) in combination with a low amplitude of the vibration movement usually only has a low depth effect

The amplitude of the vibration movement, i.e. the maximum vertical deflection of the vibratory plate, also influences the degree of compaction. Larger amplitudes can cause a more intensive compaction of the earth material, whereby the compaction comprises a large compaction depth, particularly in the case of the combination of a larger amplitude with a low frequency.

Since the invention can provide the required compressive force due to the effect of the positioning system independently of the weight of the vibration plate, it is possible to work with vibration plates of different weights. According to a first variant of the invention, a relatively light (<100 kg) vibration plate can be used and yet a high compressive force can be achieved by generating an additional contact pressure via the positioning system. In other words, the compressive force can be generated by applying a contact pressure of the positioning system acting in the same direction in addition to the gravitational force of the vibration plate. The advantage of this variant is that it is easier to handle. Lighter vibration plates are generally easier to handle and move, which can improve the efficiency of the work. They also require less energy to position and move, which can improve the overall energy efficiency of the system. When the positioning system provides much of the compressive force, the actual compressive force can be easily varied by adjusting the force that the positioning system exerts. This provides greater flexibility in adapting the compressive force to the specific requirements of the earth material to be compacted.

According to a second variant of the invention, a relatively heavy (>1,000 kg) vibration plate can be used and the adjustment of the compressive force can be achieved by exerting a lifting force via the positioning system. In other words, the compressive force can be adjusted by adjusting a lifting force of the positioning system acting against the gravitational force of the vibration plate. The advantage of this variant lies in the possibility of using heavy vibration plates with a small footprint, with which a higher pressure can be exerted on the earth material, resulting in more effective compaction. Heavy vibration plates can be difficult to handle manually, especially when they need to be lifted into specific areas, such as formwork. By using a positioning system, the tool can be precisely placed and guided, making handling easier and improving safety. By lifting the tool, the weight acting on the surface can be reduced in a controlled manner. This provides additional flexibility in adapting the compressive force to the specific requirements of the earth material to be compacted and enables finer control of the compaction process.

The degree of compaction of the earth material can preferably be determined by evaluating vibration measurement data from the vibration plate. A method for determining soil stiffness values is disclosed, for example, in WO 2005/028755 A1. In particular, at least one vibration sensor can measure the vibration behavior of the base plate, with this data being processed on a separate computing unit or directly in the control system of the positioning system. This allows real-time control of the compaction process, in which the driving speed and/or the contact pressure of the positioning system is adjusted. The control preferably runs in a feedback loop until the desired degree of compaction is achieved. In addition, the power of the vibration motor can optionally also be adjusted via the control algorithm.

The actual value of the compressive force exerted on the vibration plate by the positioning system can also be incorporated into the control of the compaction process. In this context, a preferred embodiment of the invention provides for the compressive force to be measured using a load cell, which measures the force exerted by the vibration plate on the positioning system.

With regard to the control of the compaction parameters as a function of the determined degree of compaction, a preferred embodiment of the invention provides that the compressive force is increased stepwise while the vibration plate remains in the same position as long as a target value of the degree of compaction has not been reached. The primary control variable of the control system is thus the compressive force, with the other parameters of the compaction process being left unchanged. This means that the compressive force is increased while the vibration plate remains in the same position and the frequency and amplitude of the vibration movement remain the same. Preferably, the compressive force is not readjusted continuously, but at predetermined time intervals.

The frequency and/or amplitude of the vibration movement can be used as a secondary control variable. This is preferably the case if the increase in compressive force is not sufficient to achieve the specified degree of compaction. The preferred procedure for this is that a maximum value of the compressive force is specified and the compressive force is increased stepwise until the specified maximum value is reached, and the degree of compaction is then increased by changing the frequency and/or amplitude of the vibration movement. Preferably, the vibration plate is also left in the same position during this secondary control process.

The vibration plate is not moved until the desired degree of compaction has been achieved.

Preferably, decoupling the vibration plate from the positioning system prevents the transmission of vibrations to the positioning system, such as the robot arm. Preferably, rubber-metal buffers are used as damping elements, the effective range of which is matched to the frequency band of the vibrations that occur.

In summary, the invention makes it possible to produce rammed earth elements cost-effectively, as large construction heights (>8 cm), which usually have to be compacted in several layers and work steps, can be processed in just a single work step. In addition, only as much process time as necessary is used to control the compaction quality.

According to a second aspect of the invention, the compaction method according to the invention is used to produce a clay-wood composite element. The clay-wood composite element is a wall or ceiling element of a building, wherein the composite element comprises a plurality of elongated wooden beams, between each of which an intermediate space is formed, wherein clay is introduced into the intermediate spaces and the clay in the intermediate spaces is compacted in each case by means of the compaction method according to the first aspect of the invention. The clay-wood composite element is, for example, a composite element according to EP 4015730 A1.

According to a third aspect of the invention, there is provided a device for the mechanical compaction of clayey earth material, which is particularly suitable for carrying out a method according to the first aspect of the invention, comprising a vibration plate, a triaxial positioning system on which the vibration plate is arranged, so that the vibration plate can be guided as an end effector over the earth material to be compacted and the compressive force applied to the earth material can be adjusted by actuating the positioning system perpendicular to the plate plane of the vibration plate, wherein at least one sensor is provided for determining the degree of compaction of the earth material during compaction, the measured values of which are fed to a control unit which is designed to control the compressive force, the duration of maintaining the vibration plate at the same place, the frequency of the vibration movement and/or the amplitude of the vibration movement as a function of the measured degree of compaction.

Preferred embodiments of the device according to the invention relate to design and control aspects, the technical effects and advantages of which have already been explained above in connection with the method according to the invention.

Preferably, the control unit is designed to stepwise increase the compressive force while the vibration plate remains in the same position as long as a target value of the degree of compaction has not been reached.

Preferably, the control unit is designed to increase the compressive force stepwise at predetermined, equal time intervals.

Preferably, the control unit is designed to increase the compressive force stepwise at a constant frequency and amplitude of the vibration movement as long as a target value of the degree of compaction has not been reached.

Preferably, the control unit is designed to increase the compressive force stepwise until a predetermined maximum value of the compressive force is reached, and the degree of compaction is then increased by changing the frequency and/or amplitude of the vibration movement.

Preferably, a load cell is provided which measures the force exerted by the vibration plate on the positioning system.

Preferably, the compressive force is increased by increasing a contact pressure of the positioning system acting in the same direction in addition to the gravitational force of the vibration plate.

Alternatively, the compressive force is increased by reducing a lifting force of the positioning system acting against the gravitational force of the vibration plate.

Preferably, the sensor is designed to determine vibration measurement data of the vibration plate.

### BRIEF DESCRIPTION OF THE DRAWINGS

The invention is explained in more detail below with reference to embodiments shown schematically in the drawing.

FIG. 1 shows an isometric view of the compaction tool,

FIG. 2 an exploded isometric view of the compaction tool,

FIG. 3 a side view of a compaction tool on a robot arm,

FIG. 4 a side view of a compaction tool on a portal axis and

FIG. 5 a flow diagram of a control system for the compaction process.

### DETAILED DESCRIPTION

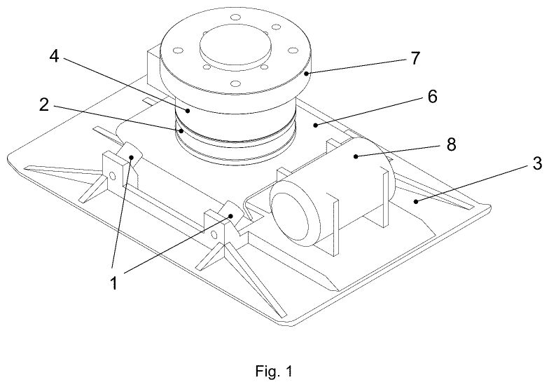

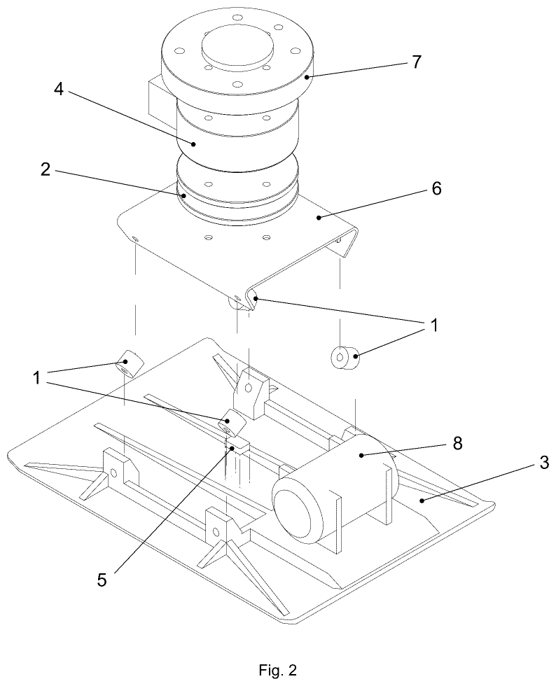

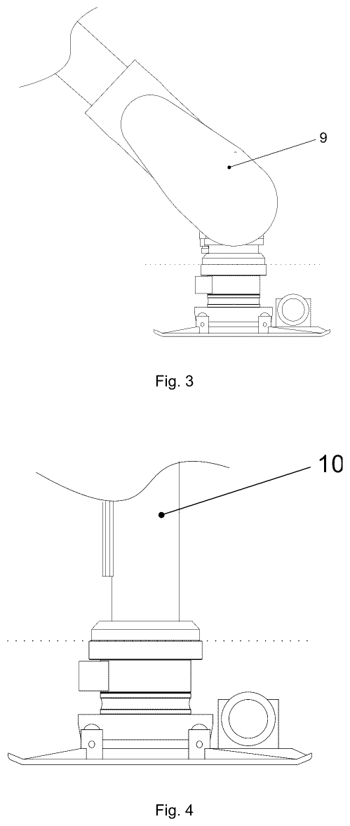

According to FIGS. 1 and 2, the compaction device according to the invention comprises a vibration plate with a rigid base plate 3 made of steel, which is optionally designed as a cast element or as a welded construction. A vibration motor 8 is mounted on the base plate 3 in such a way that it can be set into vibration directly. Optionally, a frequency converter connected to the vibration motor 8 allows the vibration frequency and force to be controlled. A metal plate 6 is connected to the base plate 8 via rubber-metal buffers 1. Another rubber-metal buffer 2 sits on the metal plate 6 and is connected to a load cell 4. Finally, an adapter plate 7 sits on the load cell 4, which allows a force-locking connection with a robot arm 9 (FIG. 3) or a mechanically guided portal axis 10 (FIG. 4). In addition, a vibration sensor 5 can be attached to the base plate 3.

The vibration sensor 5, the load cell 4, the vibration motor 8 and a frequency converter are connected to a robot controller. A control system on the robot controller evaluates the data from the load cell 4 and the vibration sensor 5 and adjusts the movements of the robot arm 9 accordingly, or regulates the frequency converter and vibration motor 8.

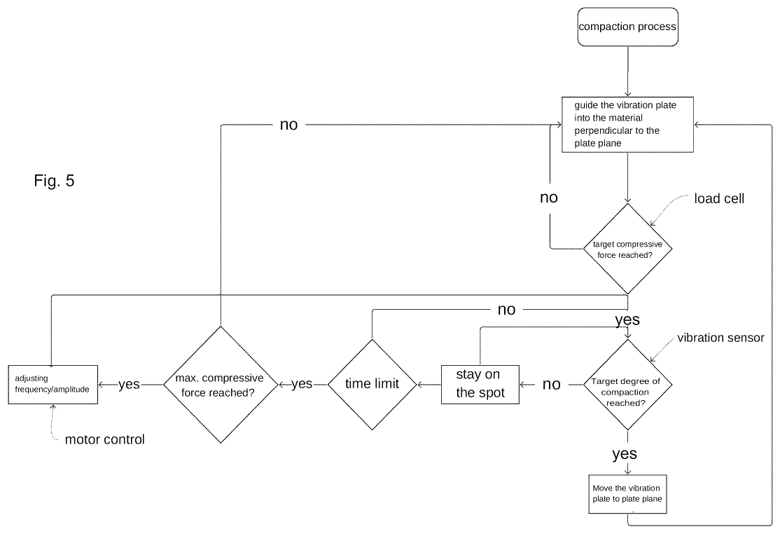

The control process is shown in FIG. 5. At the beginning of the compaction process, the vibration plate is driven perpendicular to the plate plane into the material to be compacted in order to exert a compressive force on the material. The load cell 4 is used to check whether a predetermined target compressive force has been reached. If this is not the case, the control unit returns to the previous step and causes the vibration plate to be driven further. This loop is repeated until the specified target compressive force is reached. Now the degree of compaction is measured and checked to see if the target degree of compaction has been reached. If this is not the case, the vibration plate remains in the same position and the check that the target degree of compaction has been achieved is repeated. If the target degree of compaction has still not been achieved after a specified time limit has elapsed, a check is made to see whether a specified maximum compressive force has been applied. If this is not the case, the target compressive force is adjusted and the control process returns to the first step. If, on the other hand, the specified maximum compressive force has already been applied, the amplitude and/or frequency of the vibration movement is adjusted instead of the compressive force being increased. The verification of the achievement of the target degree of compaction is now carried out with the new setting of the amplitude and/or frequency of the vibration movement and the compaction process is carried out in the manner described above until the target degree of compaction is achieved.

1-19. (canceled)

20. A method for mechanical compaction of clayey earth material by a vibration plate, comprising:
guiding the vibration plate as an end effector on a triaxial positioning system over the earth material to be compacted;
adjusting a compressive force applied to the earth material by actuating the positioning system perpendicular to a plate plane of the vibration plate, a degree of compaction of the earth material being measured during compaction; and
controlling as a function of a measured degree of compaction at least one of:
the compressive force,
a duration of maintaining the vibration plate at a same place,
a frequency of a vibration movement, and
an amplitude of the vibration movement.

21. The method according to claim 20, wherein the compressive force is increased stepwise during the maintaining of the vibration plate at the same place as long as a target value of the degree of compaction has not been reached.

22. The method according to claim 21, wherein the stepwise increase of the compressive force takes place at predetermined, equal time intervals.

23. The method according to claim 21, wherein the compressive force is increased stepwise while the frequency and amplitude of the vibration movement remain constant, as long as a target value of the degree of compaction has not been reached.

24. The method according to claim 20, wherein the compressive force is increased stepwise until a predetermined maximum value of the compressive force is reached, and the degree of compaction is then increased by changing at least one of the frequency of the vibration movement and the amplitude of the vibration movement.

25. The method according to claim 20, wherein the compressive force is measured with a load cell which measures a force acting from the vibration plate on the positioning system.

26. The method according to claim 21, wherein the compressive force is increased by increasing a contact pressure of the positioning system acting in a same direction in addition to a gravitational force of the vibration plate.

27. The method according to claim 21, wherein the compressive force is increased by reducing a lifting force of the positioning system acting against a gravitational force of the vibration plate.

28. The method according to claim 20, wherein the degree of compaction is determined by evaluating vibration measurement data of the vibration plate.

29. A method for producing a clay-wood composite element as a wall or ceiling element of a building, the composite element comprising a plurality of elongated wooden beams, between each of which an intermediate space is formed, comprising:
introducing clay into the intermediate spaces; and
compacting the clay in the intermediate spaces by mechanical compaction by a vibration plate, the compacting comprising:
guiding the vibration plate as an end effector on a triaxial positioning system over the earth material to be compacted;
adjusting a compressive force applied to the earth material by actuating the positioning system perpendicular to a plate plane of the vibration plate, a degree of compaction of the earth material being measured during compaction; and
controlling as a function of a measured degree of compaction at least one of:
the compressive force,
a duration of maintaining the vibration plate at a same place,
a frequency of a vibration movement, and
an amplitude of the vibration movement.

30. A device for the mechanical compaction of clayey earth material, comprising:
a vibration plate;
a triaxial positioning system on which the vibration plate is arranged, so that the vibration plate can be guided as an end effector over the earth material to be compacted and the compressive force applied to the earth material can be controlled by actuating the positioning system perpendicular to the plate plane of the vibration plate;
at least one sensor being for determining a degree of compaction of the earth material during the compaction; and
a control unit receiving measured values and controlling as a function of the degree of compaction at least one of:
a compressive force,
a duration of maintaining the vibration plate at the same place,
a frequency of a vibration movement, and
an amplitude of the vibration movement.

31. The device according to claim 30, wherein the control unit is configured to increase the compressive force stepwise during the maintaining of the vibration plate at the same point as long as a target value of the degree of compaction has not been reached.

32. The device according to claim 31, wherein the control unit is configured to carry out the stepwise increase of the compressive force at predetermined, equal time intervals.

33. The device according to claim 31, wherein the control unit is configured to increase the compressive force stepwise at a constant frequency and amplitude of the vibration movement as long as a target value of the degree of compaction has not been reached.

34. The device according to claim 30, wherein the control unit is configured to increase the compressive force stepwise until a predetermined maximum value of the compressive force is reached, and the degree of compaction is then increased by changing at least one of the frequency of the vibration movement and the amplitude of the vibration movement.

35. The device according to claim 30, wherein a load cell is provided which measures the force acting from the vibration plate on the positioning system.

36. The device according to claim 30, wherein the compressive force is increased by increasing a contact pressure of the positioning system acting in the same direction in addition to a gravitational force of the vibration plate.

37. The device according to claim 30, wherein the compressive force is increased by reducing a lifting force of the positioning system acting against a gravitational force of the vibration plate.

38. The device according to claim 30, wherein the at least one sensor is configured to determine vibration measurement data of the vibration plate.
